(19) United States
(12) Patent Application Publication
(10) Pub. No.: US 2022/0324084 A1
(43) Pub. Date: Oct. 13, 2022

(54) EXTERNAL PAWL RATCHET MECHANISM

(71) Applicant: Snap-on Incorporated, Kenosha, WI (US)

(72) Inventor: Joshua M. Beer, Kenosha, WI (US)

(73) Assignee: Snap-on Incorporated, Kenosha, WI (US)

(21) Appl. No.: 17/229,070

(22) Filed: Apr. 13, 2021

(51) Int. Cl. B25B 13/46; B25B 21/00

(52) U.S. Cl. CPC B25B 13/463; B25B 21/004

(57) ABSTRACT

A ratchet mechanism for a power tool having a link member including an opening, a ratchet gear having a toothed portion and adapted to be selectively driven in either of first and second drive directions, first and second pawls pivotably coupled to the link member and adapted to selectively engage with the toothed portion for selecting one of the first and second drive directions, and a crank shaft including first and second opposing ends, wherein the first end includes an offset pin received in the opening of the link member and the second end is adapted to be operably coupled to a motor.

### TECHNICAL FIELD OF THE INVENTION

The present invention relates generally to power tools. More specifically, the present invention relates to external pawl ratchet mechanisms for hand-held power tools.

### BACKGROUND OF THE INVENTION

Power tools, such as, for example, motorized ratchet wrenches, drills, and drivers, driven by electric or pneumatic motors are commonly used in automotive, industrial, and household applications to tighten and untighten work pieces, such as threaded fasteners, and to apply a torque and/or angular displacement to a work piece, for example. Power tools such as cordless power ratchets and drivers generally include an electric motor contained in a housing, along with other components, such as switches, light emitting diodes (LEDs), and batteries, for example. The housing may be a clamshell type housing that generally includes two or more housing portions coupled together by fasteners such as screws or rivets to cooperatively form the housing.

Conventional power tools have internal pawl or single external pawl ratchet mechanisms. However, these pawl ratchet mechanisms have relatively low ultimate torque. This low ultimate torque output make it difficult for power tools having these types of ratchet mechanisms to tighten and untighten work pieces with a high prevailing torque.

Other conventional pneumatic power tools have external double pawl mechanisms. However, these pawl ratchet mechanisms also have relatively low ultimate torque output due to limited impact energy caused by the pawl teeth impacting the ratchet gear teeth, which makes it difficult for power tools having these types of ratchet mechanisms to tighten and untighten work pieces with a high prevailing torque.

### SUMMARY OF THE INVENTION

The present invention relates broadly to an external dual pawl ratchet mechanism for a motorized hand-held ratcheting tool with an enlarged ratchet gear, thereby enlarging the ratchet gear teeth. By increasing the size of the ratchet gear and ratchet gear teeth, the pawls are able to better meshingly engage with the ratchet teeth and store more potential energy before impacting the ratchet gear teeth. For example, in an embodiment, the ratchet gear may have a radius in a range of about 0.5 to 0.6 inches and a tooth thickness in a range of about 0.1 to 0.2 inches. In a preferred embodiment, the ratchet gear has a radius of about 0.543 inches and a tooth thickness of about 0.132 inches. Accordingly, a motorized hand held ratcheting tool coupled with a dual pawl ratchet mechanism in accordance with the present invention has a significantly higher ultimate torque and motorized torque compared to current solutions.

In an embodiment, the present invention broadly comprises a ratchet mechanism adapted to be coupled to a hand-held powered ratcheting-type tool. The ratchet mechanism includes a link member having an opening, a ratchet gear having a toothed portion and that is adapted to be selectively driven in either of first and second drive directions, first and second pawls pivotably coupled to the link member and adapted to selectively engage the toothed portion for selecting one of the first and second drive directions, and a crank shaft including first and second opposing ends, wherein the first end includes an offset pin received in the opening of the link member and the second end is adapted to be operably coupled to a motor.

### BRIEF DESCRIPTION OF THE DRAWINGS

For the purpose of facilitating an understanding of the subject matter sought to be protected, there are illustrated in the accompanying drawings embodiments thereof, from an inspection of which, when considered in connection with the following description, the subject matter sought to be protected, its construction and operation, and many of its advantages should be readily understood and appreciated.

FIG. 1 is a perspective view of an exemplary power hand-tool, such as a motorized ratchet tool, that includes a ratchet mechanism according to an embodiment of the present invention.

FIG. 2 is a plan view of a driver portion of the power tool of FIG. 1 with a cover removed to view an embodiment of the ratchet mechanism of the present invention.

FIG. 3 is a plan view crankshaft of the ratchet mechanism, according to an embodiment of the present invention.

FIG. 4 is a plan view of a ratchet gear of the ratchet mechanism, according to an embodiment of the present invention.

FIG. 5 is a plan view of one of the pawls of the ratchet mechanism, according to an embodiment of the present invention.

### DETAILED DESCRIPTION OF THE INVENTION

While the present invention is susceptible of embodiments in many different forms, there is shown in the drawings, and will herein be described in detail, embodiments of the invention, including a preferred embodiment, with the understanding that the present disclosure is to be considered as an exemplification of the principles of the present invention and is not intended to limit the broad aspect of the invention to any one or more embodiments illustrated herein. As used herein, the term “present invention” is not intended to limit the scope of the claimed invention, but is instead used to discuss exemplary embodiments of the invention for explanatory purposes only.

The present invention relates broadly to an external dual pawl ratchet mechanism for a motorized hand-held ratcheting tool with an enlarged ratchet gear, thereby enlarging the ratchet gear teeth. By increasing the size of the ratchet gear and ratchet gear teeth, the pawls are able to store potential energy before impacting the ratchet gear teeth. For example, in an embodiment, the ratchet gear may have a radius in a range of about 0.5 to 0.6 inches and a tooth thickness in a range of about 0.1 to 0.2 inches. In a preferred embodiment, the ratchet gear has a radius of about 0.543 inches and a tooth thickness of about 0.132 inches. Accordingly, a motorized hand held ratcheting tool coupled with a dual pawl ratchet mechanism in accordance with the present invention has a higher ultimate torque and motorized torque, compared to current solutions.

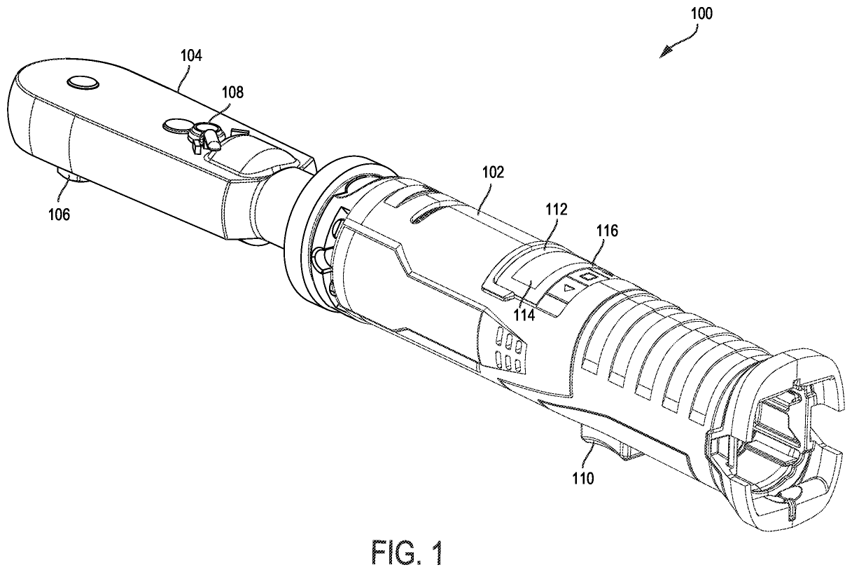

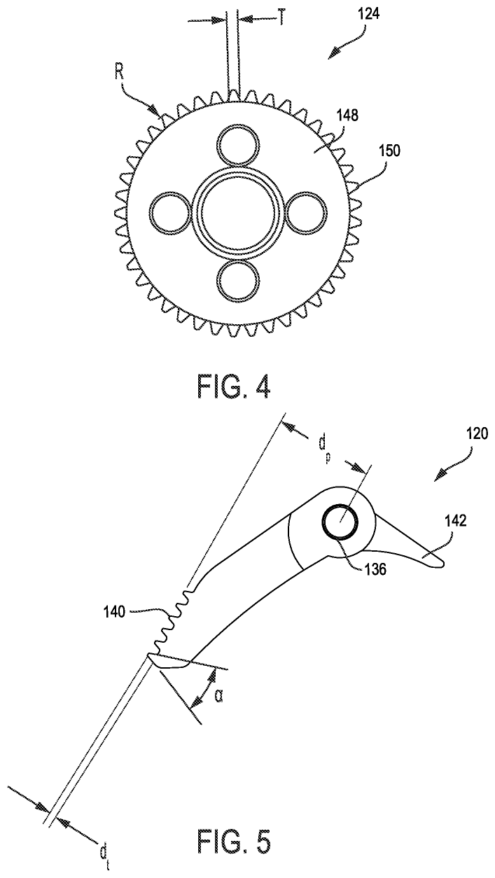

Referring to FIGS. 1-5, an exemplar power tool 100, such as, for example, a motorized hand held ratcheting tool, such as a ratchet wrench, drill, and/or driver, driven by an electric or pneumatic motor, includes a housing portion 102 adapted to be held by a user and a driver portion 104 coupled to the housing portion 102. The driver portion 104 is adapted to apply torque to a work piece and includes a drive lug 106 adapted to engage a tool (e.g., socket or bit) to drive the work piece, for example, in a well-known manner. The drive lug 106 is operatively coupled to and driven by a pneumatic or electric motor (not shown) via a ratcheting mechanism of the driver portion 104, described below. The driver portion 104 also includes a selector lever 108 adapted to select a desired rotational drive direction of the drive lug 106 (i.e., clockwise or counter-clockwise), as described below. For example, the driver portion 104 may be a ratchet head of a ratchet tool.

The housing portion 102 operably houses components of the tool 100, such as, for example, one or more of the motor adapted to drive the drive lug 106, a trigger 110 adapted to actuate the motor, a power source (not shown) adapted to provide power for the motor, such as, for example, a battery, and/or a display assembly 112 (described below). In an embodiment, the housing portion 102 is assembled from two or more clamshell housing portions coupled together to cooperatively form the housing portion 102 and couple to the driver portion 104, thereby enclosing the components within the housing portion 102. The housing portion 102 may also include or form a grip for a user to hold during operation of the tool 100.

The motor can be operably coupled to the power source via the trigger 110 in a well-known manner. The power source can be external (e.g., an electrical wall outlet, generator, external battery, etc.) or internal (e.g., a removable and/or rechargeable battery). The trigger 110 can be adapted to selectively cause the motor to be turned ON and OFF, or cause electric power/voltage to flow from the power source to the motor or cease flow from the power source to the motor.

The trigger 110 can be an actuation mechanism that employs a push button type actuator or other type of actuator. For example, the user can depress trigger 110 inwardly to selectively cause power to be drawn from the power source and cause the motor to provide torque to the driver portion 104 in a desired rotational direction. Any suitable trigger 110 or switch can be implemented without departing from the spirit and scope of the present invention. For example, the trigger 110 can be a toggle actuator, a touch sensitive actuator, a slide actuator, or other suitable actuator or device. In another example, the trigger 110 can be biased such that the trigger 110 is inwardly depressible, relative to the housing portion 102, to cause the tool 100 to operate, and releasing the trigger 110 causes the trigger 110 to move outwardly, relative to the housing portion 102, to cease operation of the tool 100 via the biased nature of the trigger 110. The trigger 110 may also be a variable speed type mechanism. In this regard, relative actuation or depression of the trigger 110 causes the motor to operate at variable speeds the further the trigger 110 is depressed.

The display assembly 112 includes a display 114 adapted to indicate tool information to a user. In an embodiment, the display 114 is an LCD. The tool information can include, for example, status of the tool, such as, for example, a power level of the power source, a selected driving direction of the drive lug 106, a power state of the motor, battery charge or condition, output torque of the tool 100, etc. The display assembly 112 may further include one or more buttons 116 adapted to receive a user input, such as, for example, selecting what is displayable on the display 114, for selecting tool parameters, such as, for example, the driving direction of the drive lug 106 or torque output, and/or for otherwise manipulating the display 114 to control the tool 100 and/or parameters of the tool 100.

The ratchet mechanism is disposed in the driver portion 104. The ratchet mechanism includes a link member 118, first 120 and second 122 pawls, a ratchet gear 124, and a crank shaft 126. The ratchet mechanism operably couples the drive lug 106 to the motor to be driven thereby when the trigger 110 is actuated.

The link member 118 includes an aperture 128 adapted to receive a post 130 to rotatably couple the link member 118 to the driver portion 104. The post 130 may be integrally formed with the driver portion 104. The link member 118 may also include an opening 132. In an embodiment, the opening 132 is arcuately shaped. The opening 132 is adapted to rotatably couple to a bushing 134.

The first 120 and second 122 pawls respectively include first 136 and second 138 pivot apertures adapted to respectively receive a pin, shaft, axle, or fastener to pivotably couple the first 120 and second 122 pawls to the link member 118. The first pawl 120 includes first pawl teeth 140 and a first finger portion 142. The second pawl 122 includes second pawl teeth 144 and a second finger portion 146. The first 140 and second 144 pawl teeth are respectively disposed at a distance dₚ from the first 136 and second 138 pivot apertures. The distance dₚ is in a range of about 0.5 to 0.6 inches. In a preferred embodiment, distance dₚ is about 0.560 inches from the first 136 and second 138 pivot apertures. In an embodiment, the depth dₜ of the first 140 and second 144 pawl teeth is in a range of about 0.04 to 0.05 inches. In a preferred embodiment, the depth dₜ of the first 140 and second 144 pawl teeth is about 0.047 inches. In an embodiment, a tooth angle α of the first 140 and second 144 pawl teeth is in a range of about 40° to 50°. In a preferred embodiment, angle α is about 47°.

The ratchet gear 124 includes a generally circular body portion 148 having circumferential toothed portion 150. The drive lug 106 may be coupled to or integral with the body portion 148. The toothed portion 118 selectively engages first 140 or second 144 pawl teeth for selective engagement with one of the first 120 and second 122 pawls to provide torque drive through the drive lug 106 in either of the first and second rotational drive directions, based on a position of the selector lever 108, as described below. The first 120 and second 122 pawls are each biased towards the ratchet gear by a biasing member 160, such as, for example, a spring. The body portion 148 of the ratchet gear has a radius R in a range of about 0.5 to 0.6 inches. In a preferred embodiment, the radius R is about 0.543 inches. The circumferential toothed portion 150 has a tooth thickness T in a range of about 0.1 to 0.2 inches. In a preferred embodiment, the tooth thickness T is about 0.132 inches.

The crank shaft 126 includes first 152 and second 154 opposing ends. The first end includes an offset pin 156. The offset pin 156 is received by the bushing 134 disposed in the opening 132 of the link member 118. The offset pin 156 is offset from a longitudinal axis of the crank shaft 126 at a distance dₒ of about 0.1 inches. The second end is operably coupled to the motor in a well-known manner.

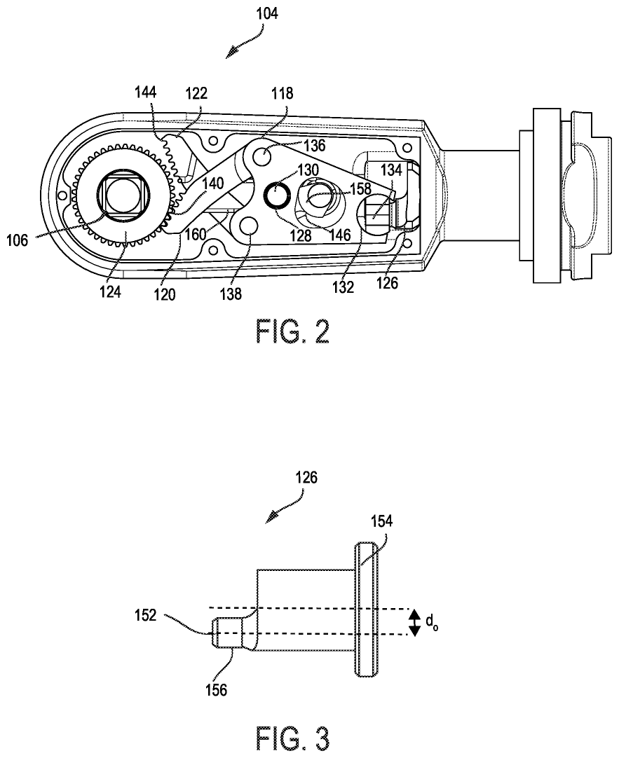

The selector lever 108 is pivotally coupled to a cam 158, such that the cam 158 co-rotates with the selector lever 108 to selectively position one of the pawls 120, 122 into engagement with the ratchet gear 124 for selecting the torque drive direction in either of the first and second rotational drive directions (i.e., clockwise and counterclockwise). For example, to select the first rotational drive direction, as illustrated in FIG. 2, the cam 158 is rotated via the selector lever 108 to abut the second finger portion 146 to overcome a bias force of the biasing member 160 to disengage the second pawl teeth 144 from the toothed portion 150 of the ratchet gear 124. To select the second rotational drive direction, the cam 158 is rotated via the selector lever 108 to abut the first finger portion 142 to overcome the bias force of the biasing member 160 to disengage the first pawl teeth 140 from the toothed portion 150 of the ratchet gear 124.

During operation, upon actuation of the trigger 110, the motor drives the crank shaft 126 to rotate about the longitudinal axis of the crank shaft 126 to drive the link member 118 back and forth about post 130, thereby correspondingly moving the pawls 120, 122. Accordingly, one of the first and second pawls 120, 122 selectively engaged with the ratchet gear 124 will drive the drive lug 106 in the selected rotational direction.

Accordingly, the ratchet mechanism disclosed herein results in outputting a high impact force followed by a relatively constant force as the ratchet mechanism is applying torque to a work piece. The ratchet mechanism disclosed herein provides more consistent and higher impact forces compared to current art solutions. As discussed above, the aspects of the present invention are described in terms of a motorized ratchet tool, as shown. However, it should be understood that aspects of the present invention could be implanted in other hand tools. For example, and without limitation, the hand tool can be a ratchet wrench, impact wrench, open wrench, screw driver, nut driver, drill, or any other tool capable of applying torque to a work piece and includes a ratchet mechanism.

As used herein, the term “coupled” can mean any physical, electrical, magnetic, or other connection, either direct or indirect, between two parties. The term “coupled” is not limited to a fixed direct coupling between two entities.

The matter set forth in the foregoing description and accompanying drawings is offered by way of illustration only and not as a limitation. While particular embodiments have been shown and described, it will be apparent to those skilled in the art that changes and modifications may be made without departing from the broader aspects of the inventors' contribution. The actual scope of the protection sought is intended to be defined in the following claims when viewed in their proper perspective based on the prior art.

What is claimed is:

1. A ratchet mechanism for a tool comprising:
a link member including an opening;
a ratchet gear having a toothed portion and adapted to be selectively driven in either of first and second drive directions;
first and second pawls pivotably coupled to the link member and adapted to selectively engage the toothed portion for selecting one of the first and second drive directions; and
a crank shaft including first and second opposing ends, wherein the first end includes an offset pin received in the opening of the link member and the second end is adapted to be operably coupled to a motor.

2. The ratchet mechanism of claim 1, wherein the first drive direction is selected when the first pawl is engaged with the toothed portion and the second pawl is disengaged from the toothed portion, and the second drive direction is selected when the first pawl is disengaged from the toothed portion and the second pawl is engaged with the toothed portion.

3. The ratchet mechanism of claim 1, further comprising a selector lever coupled with a cam, wherein the selector lever is movable between and to first and second positions respectively corresponding to the first and second drive directions.

4. The ratchet mechanism of claim 3, wherein the first and second pawls respectively include first and second finger portions, and wherein when the selector lever is disposed in the first position, the cam abuts the second finger portion and the second pawl is disengaged from the toothed portion, and when the selector lever is disposed in the second position, the cam abuts the first finger portion and the second pawl is engaged with the toothed portion.

5. The ratchet mechanism of claim 1, further comprising a biasing member adapted to apply a biasing force to the first and second pawls to bias the first and second pawls towards the ratchet gear.

6. The ratchet mechanism of claim 1, wherein the ratchet gear has a radius in a range of about 0.5 to 0.6 inches.

7. The ratchet mechanism of claim 6, wherein the radius is about 0.543 inches.

8. The ratchet mechanism of claim 6, wherein the toothed portion has a tooth thickness of a range of about 0.1 to 0.2 inches.

9. The ratchet mechanism of claim 8, wherein the tooth thickness is about 0.132 inches.

10. The ratchet mechanism of claim 6, wherein pawl teeth of the first and second pawls have a tooth angle in a range of about 40° to 50°.

11. The ratchet mechanism of claim 10, wherein the tooth angle is about 47°.
